(19) United States
(12) Patent Application Publication
(10) Pub. No.: US 2026/0305906 A1
(43) Pub. Date: Oct. 8, 2026

(54) DISHWASHER

(71) Applicant: Samsung Electronics Co., Ltd., Suwon-si (KR)

(72) Inventors: Gimun GWAK, Suwon-si (KR); Jungha PARK, Suwon-si (KR); Hyunjun CHUNG, Suwon-si (KR); Hyeonho LEE, Suwon-si (KR); Kisup LEE, Suwon-si (KR); Changhoon OH, Suwon-si (KR); Wonyoung SEO, Suwon-si (KR)

(21) Appl. No.: 19/462,156

(22) Filed: Jan. 28, 2026

Related U.S. Application Data
(63) Continuation of application No. PCT/KR2026/000902, filed on Jan. 15, 2026.

(30) Foreign Application Priority Data
Feb. 24, 2025 (KR) 10-2025-0023961

(51) Int. Cl. A47L 15/42

(52) U.S. Cl. CPC A47L 15/4229

(57) ABSTRACT

A dishwasher comprises a tub, an injection unit comprising a nozzle configured to inject washing water inside of the tub, a sump configured to accommodate washing water to be supplied to the injection unit, and a water treatment device configured to treat washing water to be supplied to the sump. The water treatment device includes a case including an inlet port and a discharge port, a deionization module comprising an electrode capable of adsorbing ionic substances contained in water supplied through the inlet port, and an accommodation portion comprising a chamber provided on a flow path through which water supplied through the inlet port flows to the deionization module, the accommodation portion being capable of accommodating a regenerative material for removing ions adsorbed on the deionization module.

### CROSS-REFERENCE TO RELATED APPLICATIONS

This application is a continuation of International Application No. PCT/KR2026/000902 designating the United States, filed on Jan. 15, 2026, in the Korean Intellectual Property Receiving Office and claiming priority to Korean Patent Application No. 10-2025-0023961, filed on Feb. 24, 2025, in the Korean Intellectual Property Office, the disclosures of each of which are incorporated by reference herein in their entireties.

### BACKGROUND

### Field

The disclosure relates to a dishwasher including a water treatment device.

### Description of Related Art

A dishwasher is a device that injects washing water at a high pressure into dishes accommodated therein, washes and dries the dishes. A dishwasher operates to inject washing water at a high pressure into the inside of a washing chamber in which dishes are accommodated and hit the injected washing water to the dishes, thereby washing away food residue and other debris stuck on surfaces of the dishes.

A dishwasher may include a tub to form a washing chamber and a sump mounted on a lower surface of the tub to store water. Water moves to an injection nozzle by a pumping action of a washing pump mounted inside the sump. The water moved to the injection nozzle is injected at a high pressure through an injection hole formed in the injection nozzle. As the injected high-pressure water hits surface of dishes, food residue and other debris stuck on the dishes fall to the lower surface of the tub.

A dishwasher may include a water treatment device capable of converting raw water supplied from a water supply source into soft water. As an example, the water treatment device may include a capacitive deionization (CDI) device. The water treatment device may produce soft water by adsorbing ionic substances contained in raw water. Because the water treatment device has a limited adsorption capacity depending on an electrostatic capacity, periodic regeneration is required. As a time for the water treatment device to perform a water treatment process increases, scale may accumulate on electrodes, which may reduce the efficiency of the water treatment process.

### SUMMARY

Embodiments of the disclosure provide a dishwasher having an improved structure.

A dishwasher according to an example embodiment of the present disclosure includes: a tub, an injection unit comprising a nozzle configured to inject washing water inside of the tub, a sump configured to accommodate washing water to be supplied to the injection unit, and a water treatment device configured to treat washing water to be supplied to the sump. The water treatment device includes: a case including an inlet port and a discharge port, a deionization module comprising an electrode capable of adsorbing ionic substances contained in water supplied through the inlet port, and an accommodation portion comprising a chamber provided on a flow path through which water supplied through the inlet port flows to the deionization module, the accommodation portion being configured to accommodate a regenerative material for removing ions adsorbed on the deionization module.

A dishwasher according to an example embodiment of the present disclosure includes: a tub, an injection unit comprising a nozzle configured to inject washing water from the inside of the tub, a sump configured to accommodate washing water to be supplied to the injection unit, and a water treatment device configured to treat washing water to be supplied to the sump. The water treatment device includes: a case including an inlet port, a discharge port, and a supply opening open toward the inside of the tub, a deionization module comprising an electrode configured to adsorb ionic substances contained in water supplied through the inlet port, an accommodation portion provided on a flow path through which water supplied through the inlet port flows to the deionization module, the accommodation portion configured to accommodate a regenerative material for removing ions adsorbed on the deionization module, and a guide portion configured to guide water from the accommodation portion to the deionization module, the guide portion including an air hole located at a higher position than the inlet port.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a side cross-sectional view of a dishwasher according to various embodiments.

FIG. 2 is a partial perspective view illustrating various components inside a housing of the dishwasher according to various embodiments.

FIG. 3 is a partial perspective view illustrating example arrangements of a water treatment device and a case break for a tub of the dishwasher according to various embodiments.

FIG. 4 is a diagram, a connection relationship of components related to flows of washing water in the dishwasher according to various embodiments.

FIG. 5 perspective view illustrating the water treatment device of the dishwasher according to various embodiments.

FIG. 6 is a cross-sectional view taken along line A-A' of FIG. 5 according to various embodiments.

FIG. 7 is an enlarged cross-sectional view of area B of FIG. 6 according to various embodiments.

FIG. 8 is a diagram illustrating an example process of purifying water passing through the water treatment device according to various embodiments.

FIG. 9 is a diagram illustrating an example process of removing scale in the water treatment device according to various embodiments.

FIG. 10 is a cross-sectional view illustrating a state in which a regenerative material is put into the water treatment device according to various embodiments.

FIG. 11 illustrates a portion of a cross-sectional view taken along line C-C' of FIG. 5 according to various embodiments.

FIG. 12 is a diagram illustrating a connection relationship of the components related to flows of washing water in the dishwasher according to various embodiments.

### DETAILED DESCRIPTION

Various embodiments and terms in this disclosure are not intended to limit the technical features described in this disclosure to specific embodiments, and should be understood to include various modifications, equivalents, or substitutes of the various embodiments.

In connection with the description of the drawings, like reference numbers may be used for like or related components.

The singular form of a noun corresponding to an item may include one item or a plurality of items, unless the relevant context clearly dictates otherwise.

In this disclosure, each of phrases such as "A or B," "at least one of A and B," "at least one of A or B," "A, B or C," "at least one of A, B and C," and "at least one of A, B, or C" may include any one of the items listed together in the corresponding one of the phrases, or all possible combinations thereof.

The term "and/or" includes any combination of a plurality of related components or any one of a plurality of related components.

Terms such as "first," "second," "primary," and "secondary" may simply be used to distinguish a given component from other corresponding components, and do not limit the corresponding components in any other aspect (e.g., importance or order).

When any (e.g., a first) component is referred to as being "coupled" or "connected" to another (e.g., a second) component with or without the terms "functionally" or "communicatively," the component may be connected to the other component directly (e.g., by a wire), wirelessly, or through a third component.

The terms "includes," "has," and the like are intended to indicate that there are features, numbers, steps, operations, components, parts, or combinations thereof described in this disclosure, and do not exclude the presence or addition of one or more other features, numbers, steps, operations, components, parts, or combinations thereof.

When any component is referred to as being "connected," "coupled," "supported" or "in contact" with another component, this includes a case in which the components are indirectly connected, coupled, supported, or in contact with each other through a third component as well as directly connected, coupled, supported, or in contact with each other.

When any component is referred to as being located "on" or "over" another component, this includes not only a case in which any component is in contact with another component but also a case in which another component is present between the two components.

The terms "unit," "module," and "member" may be implemented as hardware or software. Depending on embodiments, a plurality of "units," "modules," and "members" may be implemented as one component, or one "unit," "module," and "member" may include a plurality of components.

Terms such as "~unit," "~part," "~block," "~member," "~module," and the like may denote a unit for processing at least one function or operation. For example, the terms may refer to at least one hardware such as a field-programmable gate array (FPGA)/an application specific integrated circuit (ASIC), at least one software stored in memory, or at least one process processed by a processor. The terms "front," "rear," "left," "right," "upper," "lower," etc., used in the following description are defined based on the drawings, but the shape and position of each component are not limited by these terms. For example, a front side may be defined as a +X side, and a rear side may be defined as a -X side. For example, based on the drawings, a right side may be defined as a +Y side, and a left side may be defined as a -Y side. For example, based on the drawings, an upper side may be defined as a +Z side, and a lower side may be defined as a -Z side.

An identification number assigned to each step is used to identify each step, the identification numerals do not describe the order of the steps, and each step may be performed differently from the order specified unless the context clearly states a particular order.

Hereinafter, various example embodiments of the present disclosure will be described in greater detail with reference to the accompanying drawings.

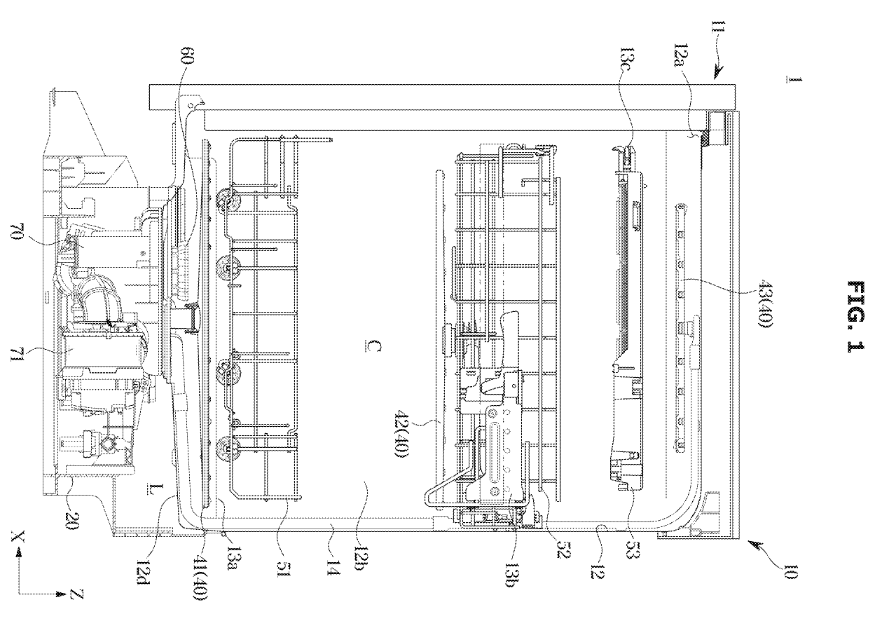

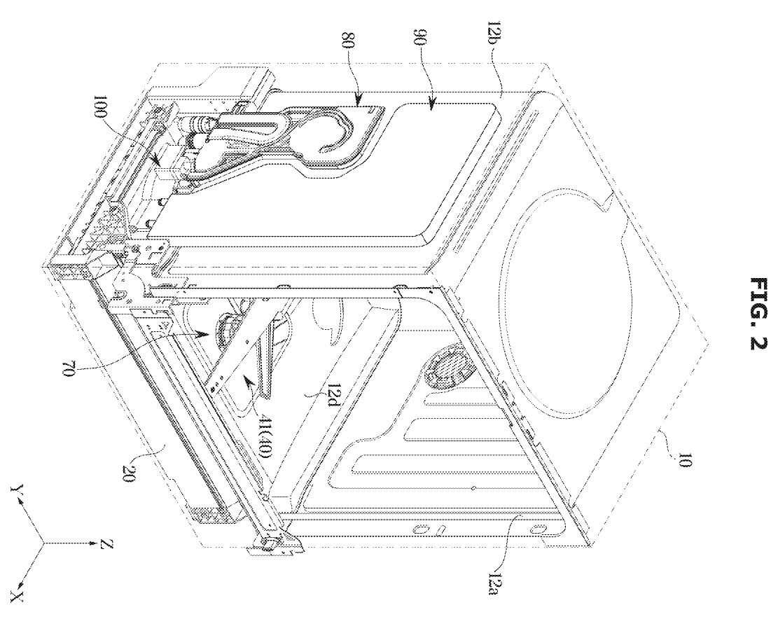

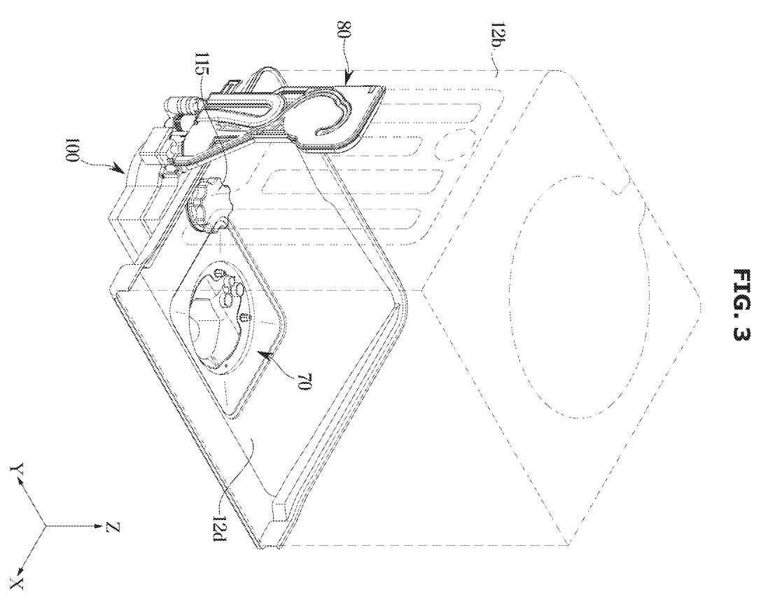

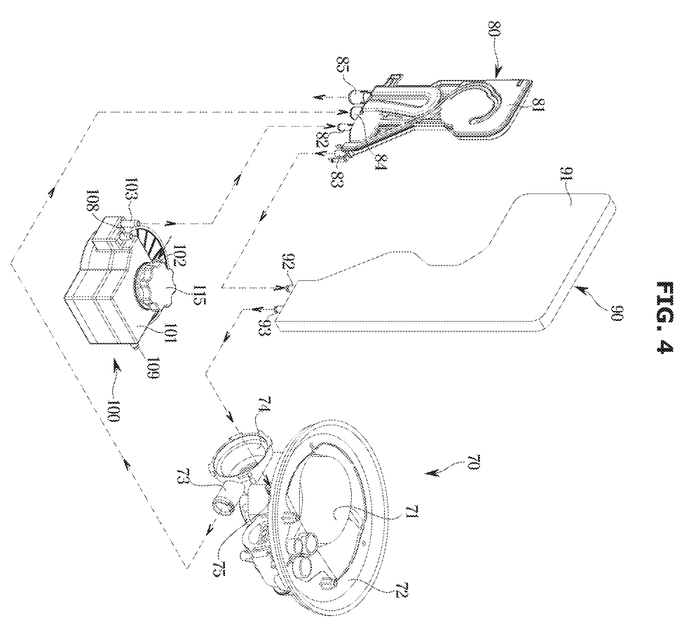

FIG. 1 is a side cross-sectional view of a dishwasher according to various embodiments. FIG. 2 is a partial perspective view illustrating various components inside a housing of the dishwasher according to various embodiments. FIG. 3 is a partial perspective view illustrating example arrangements of a water treatment device and a case break for a tub of the dishwasher according to various embodiments. FIG. 4 is a diagram illustrating a connection relationship of components related to flows of washing water in the dishwasher according to various embodiments.

Referring to FIGS. 1 to 4, a dishwasher 1 may include a housing 10. The housing 10 may form an outer appearance of the dishwasher 1. Various components for operations of the dishwasher 1 may be positioned inside the housing 10.

The dishwasher 1 may include a tub 12 provided inside the housing 10. The tub 12 may be provided in a substantially box shape. As an example, the tub 12 may have a box shape with one side open. The tub 12 may have an opening 12a. The opening 12a may be formed at the front of the tub 12.

The dishwasher 1 may include an accommodation space C formed by the tub 12. The accommodation space C may be defined as an inner space of the tub 12. The accommodation space C may be formed inside the housing 10.

The accommodation space C of the dishwasher 1 may be referred to as a washing chamber C. The washing chamber C may refer to a space in which dishes held in a receiving container are washed and dried.

The dishwasher 1 may include a door 11 provided to open and close an opening 12a of the tub 12. The door 11 may be installed on the housing 10 to open and close the opening 12a of the tub 12. The door 11 may be detachably mounted on the housing 10. The door 11 may be rotatably mounted on the housing 10. For example, the door 11 may be rotatably coupled to the housing 10 through a hinge.

The dishwasher 1 may include the receiving container provided inside the tub 12 to receive dishes.

The receiving container may include a plurality of baskets 51, 52, and 53. The plurality of baskets 51, 52, and 53 may be provided to receive a variety of tableware. However, the receiving container is not limited thereto and may include a single basket.

The receiving container may include a middle basket 52 positioned in a substantially central portion in a height direction (Z direction) of the dishwasher 1. The middle basket 52 may be introduced into or withdrawn from the washing chamber C through the opening 12a of the tub 12. The middle basket 52 may be provided to be supported on a middle guide rack 13b. For example, the middle basket 52 may be provided to be slidably movable by the middle guide rack 13b. For example, the middle guide rack 13b may be installed on an inner surface of the tub 12.

The receiving container may include a lower basket 51 positioned on a substantially lower side in the height direction (Z direction) of the dishwasher 1. The lower basket 51 may be introduced into or withdrawn from the washing chamber C through the opening 12a of the tub 12. The lower basket 51 may be provided to be supported on a lower guide rack 13a. For example, the lower basket 51 may be provided to be slidably movable by the lower guide rack 13a. For example, the lower guide rack 13a may be installed on the inner surface of the tub 12.

Tableware of relatively large volume may be received in a plurality of baskets 51 and 52. However, the types of tableware received in the plurality of baskets 51 and 52 are not limited to tableware of relatively large volume. For example, not only tableware of relatively large volume but also tableware of relatively small volume may be received in the plurality of baskets 51 and 52.

The receiving container may include an upper basket 53 positioned on an upper side in the height direction (Z direction) of the dishwasher 1. The upper basket 53 is formed in the form of a rack assembly so that tableware of relatively small volume may be received. For example, cooking tools or cutlery such as ladles, knives, and spatulas may be received in the upper basket 53. Small cups, such as espresso cups, may be stored in the upper basket 53. However, the types of tableware received in the upper basket 53 are not limited to the above example.

The upper basket 53 may be introduced into or withdrawn from the washing chamber C through the opening 12a of the tub 12. The upper basket 53 may be provided to be supported on an upper guide rack 13c. For example, the upper basket 53 may be provided to be slidably movable by the upper guide rack 13c. For example, the upper guide rack 13c may be installed on the inner surface of the tub 12.

The dishwasher 1 may include an injection device 40 provided to inject washing water. The injection device 40 may inject washing water into the washing chamber C. The injection device 40 may inject washing water toward dishes received in the receiving container. The injection device 40 may be supplied with washing water from a sump 70.

The injection device 40 may include at least one injection unit. For example, the injection device 40 may include a plurality of injection units 41, 42, and 43.

For example, the injection device 40 may include the first injection unit 41 disposed at a lower portion of the lower basket 51 in the height direction (Z direction) of the dishwasher 1. The injection device 40 may include the second injection unit 42 disposed at a lower portion of the middle basket 52 in the height direction (Z direction) of the dishwasher 1. The injection device 40 may include the third injection unit 43 disposed at an upper portion of the upper basket 53 in the height direction (Z direction) of the dishwasher 1. However, the injection device is not limited thereto and may include two or fewer or four or more injection units.

Each of the plurality of injection units 41, 42, and 43 may be provided to inject washing water while rotating. That is, each of the first injection unit 41, the second injection unit 42, and the third injection unit 43 may be provided to inject washing water while rotating. The plurality of injection units 41, 42, and 43 may be referred to as a plurality of the injection rotors 41, 42, and 43. The first injection unit 41, the second injection unit 42 and the third injection unit 43 may be referred to as the first injection rotor 41, the second injection rotor 42 and the third injection rotor 43, respectively.

However, the injection device 40 may also inject washing water in a manner different from the example described above. For example, the first injection unit 41, unlike the second injection unit 42 and the third injection unit 43, may be fixed to one side of a lower surface 12d of the tub 12. In this case, the first injection unit 41 may be provided to inject washing water in a substantially horizontal direction by a fixed nozzle, and the washing water injected in a substantially horizontal direction from the nozzle of the first injection unit 41 may move upward as a direction thereof is diverted by a diversion assembly (not shown) disposed inside the washing chamber C. The diversion assembly may be installed on a rail (not shown) to be translationally movable along the rail. Although an example has been described for the first injection unit 41, the second injection unit 42 and the third injection unit 43 may also be provided to inject washing water using fixed nozzles, similar to the example described above.

The dishwasher 1 may include the sump 70. The sump 70 may be provided to be capable of accommodating washing water. The sump 70 may collect washing water from the washing chamber C. For example, in order for the sump 70 to smoothly collect washing water, the lower surface 12d of the tub 12 may be provided to be inclined downward toward the sump 70. Washing water in washing chamber C may flow through the inclination of the lower surface 12d of the tub 12 and be smoothly introduced into the sump 70.

The dishwasher 1 may include a circulation pump 71 configured to pump washing water stored in the sump 70 to the injection device 40. The circulation pump 71 may be configured as one component of the sump 70. The circulation pump 71 may be disposed in a machine chamber L.

The sump 70 may be configured to supply washing water to at least one of the plurality of injection units 41, 42, and 43. The sump 70 may be configured to selectively supply washing water to the plurality of injection units 41, 42, and 43.

The dishwasher 1 may include a pipe 14. The pipe 14 may be provided to guide washing water from the sump 70 to the injection device 40. The pipe 14 may include a shape of extending in a substantially height direction (Z direction).

The dishwasher 1 may include the machine chamber L, which is a space provided below the tub 12. The machine chamber L may be where components for circulating washing water are disposed. The dishwasher 1 may include a base frame 20 forming the machine chamber L. The machine chamber L may be partitioned from the washing chamber C.

At least a portion of the sump 70 may be disposed in the machine chamber L. For example, most of the sump 70 may be disposed in the machine chamber L. For example, an area occupied by the washing chamber C in an area of the sump 70 may be smaller than an area occupied by the machine chamber L in the area of the sump 70. An area of the washing chamber C may be secured by reducing the area occupied by the sump 70 in the washing chamber C. Accordingly, the capacity of the washing chamber C may be increased, thereby improving dish receiving capacity.

The dishwasher 1 may include a filter 60. The filter 60 may be configured to filter out foreign substances contained in washing water to be introduced into the sump 70. The washing water filtered by the filter 60 may be delivered to the injection device 40 by the sump 70. The filter 60 may be detachably mounted on the sump 70. For example, the filter 60 may include at least one of a fine filter, a coarse filter, and a micro filter.

The dishwasher 1 may include a case break 80 coupled to one side wall 12b of the tub 12. For example, the case break 80 may be coupled to an outer wall of the tub 12. Also, the case break 80 may be disposed at a lower portion of the outer wall of the tub 12. As an example, the case break 80 may be supplied with washing water from the water treatment device 100. The case break 80 may guide water to the sump 70.

The dishwasher 1 may include a water tank 90. The water tank 90 may be provided to store water for supply to the washing chamber C. As an example, the water tank 90 may be provided to temporarily store washing water supplied from the case break 80. For example, the water tank 90 may be provided to be capable of storing washing water treated in the water treatment device 100. The water tank 90 may be disposed on one side of the tub 12. The water tank 90 may be disposed on an outer side of the side wall 12b of the tub 12. The water tank 90 may guide water to the sump 70. As an example, the water tank 90 may be omitted, and a washing water outlet 83 of the case break 80 may be connected to the sump 70.

The case break 80, the water tank 90, the sump 70, and the water treatment device 100 are each connected by hoses through which washing water flows, but for convenience of explanation, will be described with the hoses omitted. Also, examples of hoses are omitted from the drawings.

The case break 80 is provided to be connected to a communication hole formed on the side wall 12b of the tub 12.

The case break 80 may prevent/reduce washing water passed through the case break 80 from flowing back into the water treatment device 100 connected to the case break 80. The case break 80 may include an air break provided to prevent/reduce washing water from flowing back into the water treatment device 100.

The air break may include an air break hole provided to allow a flow path inside the case break 80 to be opened to the outside so that the flow path through which washing water flows inside the case break 80 is communicated with the outside.

The inside and/or internal flow path of the case break 80 and the atmosphere may be pressure equilibrated by the air break hole.

The air break may be provided to prevent/reduce washing water from flowing back due to a siphon shape when the water supply is interrupted.

The air break may be provided such that when washing water is introduced into the case break 80 at a level exceeding a predetermined hydraulic pressure or flow rate, the washing water is introduced into the tub 12 through the air break.

The case break 80 may include a case body 81 forming the internal flow path, a washing water inlet 82 provided to allow washing water softened in the water treatment device 100 to be introduced into the case body 81, and the washing water outlet 83 provided to allow washing water to pass through the internal flow path of the case break 80 and be discharged from the case body 81.

The washing water introduced into the case body 81 through the washing water inlet 82 may flow to the air break, and the washing water passed through the air break may flow to the washing water outlet 83 to flow out toward the sump 70.

The case break 80 may include a drain inlet 84 into which washing water drained from the sump 70 is introduced, and a drain outlet 85 provided to allow washing water introduced the case body 81 through the drain inlet 84 to be drained to the outside. The drain outlet 85 may be connected to the outside through a hose.

The dishwasher 1 may include the water treatment device 100 configured to soften water to be supplied from the outside to the sump 70. The softening of water may include removing ions from water. The removing of ions from water may include removing ionic substances from water. As an example, the water treatment device 100 may be supplied with water from an external water supply source.

The water treatment device 100 may be disposed upstream of the case break 80 so that the softened washing water flows into the case break 80. The water treatment device 100 may be disposed at a lower side of the tub 12. As an example, at least a portion of the water treatment device 100 may be positioned in the machine chamber L. For example, a portion of the water treatment device 100 may be disposed below the lower surface 12d of the tub 12. The water treatment device 100 may be accommodated inside the housing 10.

Because the water treatment device 100 is disposed inside the housing 10, even though washing water leaks out of the water treatment device 100, the washing water may not leak outside the housing 10.

As an example, the water treatment device 100 may include a capacitive deionization (CDI) device.

The sump 70 may include a collection portion 71. As an example, the collection portion 71 may collect washing water passed through the water treatment device 100 and the case break 80 in sequence. As an example, the collection portion 71 may collect washing water passed through the water treatment device 100, the case break 80, and the water tank 90, in sequence. The collection portion 71 may include an opening to allow water to be collected. The collection portion 71 may be provided on one side of the sump 70 facing the tub 12.

The sump 70 may include a seating portion 72. The lower surface 12d of the tub 12 may be seated on the seating portion 72. The tub 12 may be coupled with the sump 70.

The sump 70 may include a sump drain portion 73. The sump drain portion 73 may be provided such that water collected in the collection portion 71 is drained therethrough. The sump drain portion 73 may allow water to be drained to the drain inlet 84 of the case break 80. The water introduced into the case break 80 through the drain inlet 84 may be discharged to the outside through the drain outlet 85.

As an example, a check valve may be provided in the sump drain portion 73. The check valve may reduce backflow of water. For example, the check valve may be disposed at one end of the sump drain portion 72.

The sump 70 may include a drain pump coupling portion 74. In the drain pump coupling portion 74, a drain pump configured to pump water to drain water collected after a washing process may be provided.

The sump 70 may include a sump inlet port 75. As an example, the sump inlet port 75 may be connected to a separate hose connected to the washing water outlet 83 of the case break 80. As an example, the sump inlet port 75 may be connected to a separate hose connected to a tank outlet 93 of the water tank 90. Washing water inside the case break 80 may flow into the sump 70 through the sump inlet port 75. The water flowed into the sump 70 may be collected in the collection portion 71.

As an example, the sump inlet port 75 may be provided to allow washing water passed through the water treatment device 100 and the case break 80 in sequence to be collected into the sump 70. As an example, the sump inlet port 75 may be provided to allow washing water passed through the water treatment device 100, the case break 80, and the water tank 90 in sequence to be collected into the sump 70.

The dishwasher 1 may include the water tank 90 configured to store washing water passed through the water treatment device 100. The water tank 90 may be configured to temporarily store washing water passed through the water treatment device 100 and then flow to the sump 70.

The water tank 90 may include a tank case 91, a tank inlet 92 through which washing water is introduced into the tank case 91, and the tank outlet 93 through which the washing water introduced through the tank inlet 92 is discharged.

As an example, washing water passed through the water treatment device 100 may pass through the case break 80 and be introduced into the water tank 90. For example, the tank inlet 92 of the water tank 90 may be connected to the washing water outlet 83 of the case break 80. For example, the tank outlet 93 of the water tank 90 may be connected to the sump inlet port 75 of the sump 70.

The water tank 90 may be coupled to the side wall 12b of the tub 12 on which the case break 80 is disposed. The water tank 90 may be coupled to the outer wall of the tub 12 to which the case break 80 is coupled.

The water tank 90 may be disposed at a portion where the case break 80 is not located on a surface of the side wall 12b of the tub 12.

A space between the tub 12 and the housing 10 may be minimized/reduced as the water tank 90 and the case break 80 are disposed on the same side of the tub 12. For example, a width of the water tank 90 from an outer surface of the tub 12 toward the housing 10 may be provided to be similar to a width of the case break 80 from the outer surface of the tub 12 toward the housing 10. According to this configuration, the dishwasher 1 according to an embodiment of the present disclosure may maximize/increase the capacities of the case break 80 and the water tank 90 in the space between the housing 10 and the tub 12 on which the case break 80 and the water tank 90 are disposed.

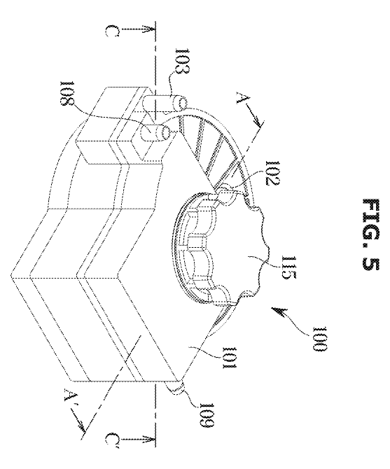

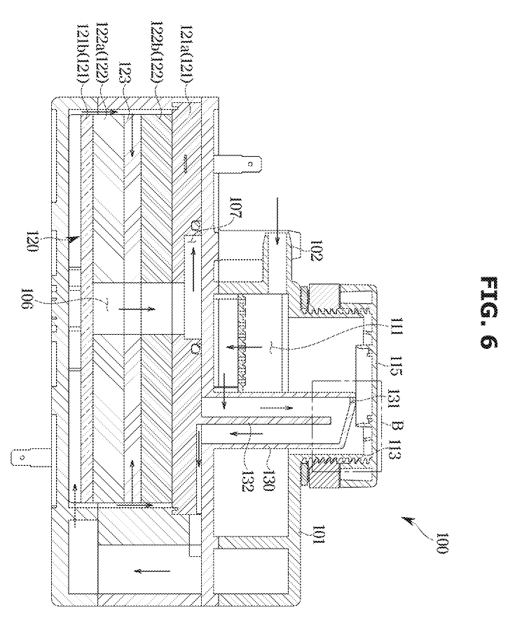

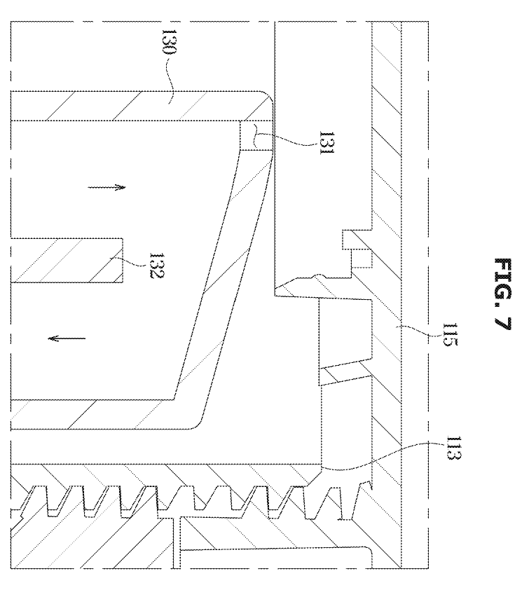

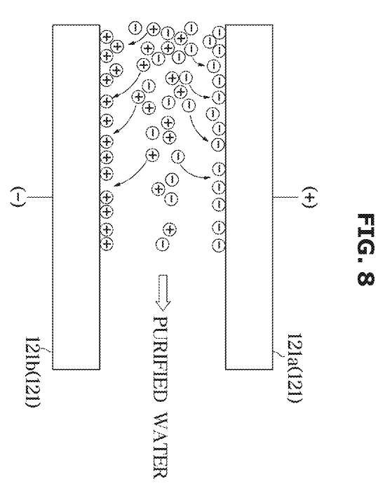

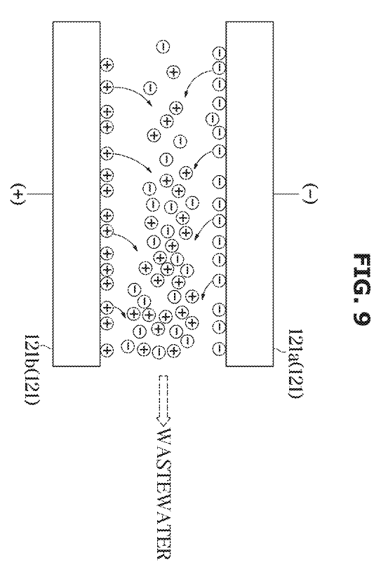

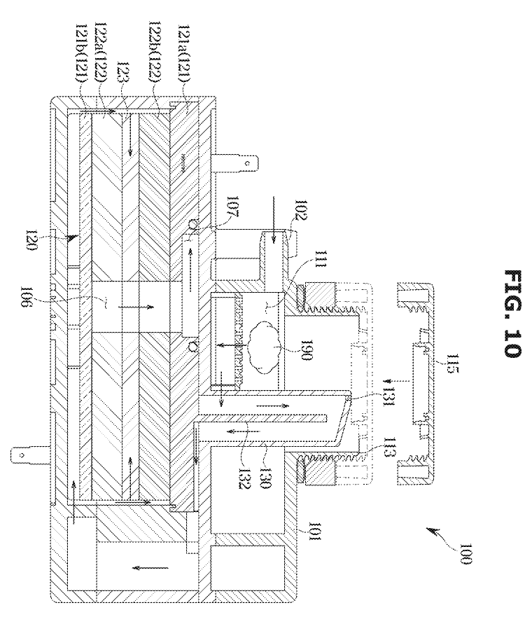

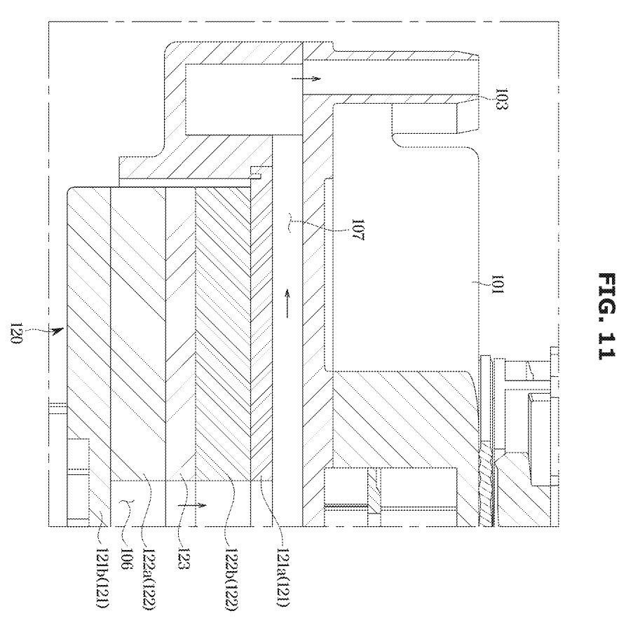

FIG. 5 is a perspective view illustrating the water treatment device of the dishwasher according to various embodiments. FIG. 6 is a cross-sectional view taken along line A-A' of FIG. 5 according to various embodiments. FIG. 7 is an enlarged view of area B of FIG. 6 according to various embodiments. FIG. 8 is a diagram illustrating an example process of purifying water passing through the water treatment device according to various embodiments. FIG. 9 is a diagram illustrating an example process of removing scale in the water treatment device according to various embodiments. FIG. 10 is a cross-sectional view illustrating a state in which a regenerative material is put into the water treatment device according to various embodiments. FIG. 11 is a portion of a cross-sectional view taken along line C-C' of FIG. 5 according to various embodiments.

Referring to FIGS. 4 to 6, the water treatment device 100 of the dishwasher 1 according to an embodiment of the present disclosure may be configured to perform water treatment on washing water to be supplied to the sump 70. As an example, the water treatment device 100 may be configured to adsorb and remove ions from washing water flowing between two electrodes by applying charges to the two electrodes, and soften the washing water by reversing an electrode voltage to desorb the ions adsorbed on the electrode from the electrode.

The water treatment device 100 may include a case 101. Components of the water treatment device 100 may be accommodated inside the case 101. The case 101 may form an outer appearance of the water treatment device 100. The case 101 may include an inlet port 102 provided to allow water to be introduced into the water treatment device 100, and a discharge port 103 provided to allow water to be discharged from the water treatment device 100. As an example, the inlet port 102 and the discharge port 103 may be provided to face different directions.

As an example, the inlet port 102 of the water treatment device 100 may be connected to a water supply source. Water supplied from the water supply source may be introduced into the water treatment device 100 through the inlet port 102.

As an example, the discharge port 103 of the water treatment device 100 may be connected to the washing water inlet 82 of the case break 80. Water passed through the water treatment device 100 may be introduced into the case break 80.

The water treatment device 100 according to an embodiment of the present disclosure may include a connection inlet 108 connectable to the washing water outlet 83 of a case break 80. The water treatment device 100 may include a connection outlet 109 connectable to the tank inlet 92 of the water tank 90. Washing water introduced through the connection inlet 108 may be discharged through the connection outlet 109. A flow path connecting the connection inlet 108 and the connection outlet 109 may be partitioned from a flow path connecting the inlet port 102 and the discharge port 103. The connection inlet 108 and the connection outlet 109 may be omitted, and the case break 80 may be directly connected to the water tank 90.

The water treatment device 100 may include an accommodation portion 111 provided on a flow path through which water supplied through the inlet port 102 flows to a deionization module 120. The accommodation portion 111 may be configured to be capable of accommodating a regenerative material 190 (see FIG. 11) provided to remove ions adsorbed on the deionization module 120.

As an example, the water treatment device 100 may include a supply opening 113 for communicating the accommodation portion 111 with the outside of the case 101. The supply opening 113 may be provided to allow the regenerative material 190 to be put into the accommodation portion 111. As an example, the supply opening 113 may be opened toward the inside of the tub 12.

The water treatment device 100 may include a supply cover 115 provided to open and close the supply opening 113. The supply cover 115 may be detachably mounted on the case 101 of the water treatment device 100. When the supply cover 115 is mounted on the case 101 to close the supply opening 113, the supply cover 115 may be positioned inside the tub 12.

Because the water treatment device 100 according to an embodiment of the present disclosure includes the accommodation portion 111 capable of accommodating the regenerative material 190 for removing ions adsorbed on the deionization module 120, a separate device (such as a reservoir and/or pump) for supplying the regenerative material 190 to the deionization module 120 may be omitted.

The water treatment device 100 may include a guide portion 130 provided to guide water in the accommodation portion 111 to the deionization module 120. As an example, water passed through the accommodation portion 111 may flow upward inside the guide portion 130 and then be redirected to flow downward. For example, a guide plate 132 extending in a vertical direction may be provided inside the guide portion 130.

Referring to FIG. 7, the water treatment device 100 may include an air hole 131 provided to communicate the inside and outside of the guide portion 130. For example, the air hole 131 may be positioned at an upper end of the guide portion 130. For example, the air hole 131 may be located at a higher position than the inlet port 102. The air hole 131 may be provided to allow air inside the guide portion 130 to be discharged to the outside of the guide portion 130.

The water treatment device 100 according to an embodiment of the present disclosure may be configured such that the supply opening 113 may be opened and closed by the supply cover 115 in order to put the regenerative material 190 into the accommodation portion 111. As the supply opening 113 is opened and closed by the supply cover 115, air may be introduced into the inside of the case 101 of the water treatment device 100. As the water treatment device 100 according to an embodiment of the present disclosure is configured such that air inside the guide portion 130 may be discharged to the outside of the guide portion 130 by the air hole 131, the water treatment device 100 may reduce the formation of air pockets inside the guide portion 130. As the water treatment device 100 according to an embodiment of the present disclosure is configured such that air inside the guide portion 130 may be discharged to the outside of the guide portion 130 by the air hole 131, the water treatment device 100 may reduce air supplied to the deionization module 120 together with water.

The water treatment device 100 may include the deionization module 120 capable of adsorbing ionic substances contained in water supplied through the inlet port 102. The deionization module 120 may include a capacitive deionization (CDI) module in which a plurality of electrodes 121 is stacked.

The deionization module 120 may be disposed inside the case 101. As an example, the deionization module 120 may have a cylindrical shape with a hollow space 106 formed in a central portion thereof. The deionization module 120 may be configured to allow water to pass through.

A voltage may be applied to each of the two electrodes 121 provided on both sides of the deionization module 120. For example, the electrode 121 provided on a first side of the deionization module 120 may be an anode, and the electrode 121 provided on a second side opposite to the first side of the deionization module 120 may be a cathode. For example, the electrode 121 provided on the first side of the deionization module 120 may be a cathode, and the electrode 121 provided on the second side opposite to the first side of the deionization module 120 may be an anode.

The deionization module 120 may include the electrode 121, an ion exchange membrane 122, and a spacer 123. The deionization module 120 may have a structure in which the electrode 121, the ion exchange membrane 122, and the spacer 123 are stacked in a predetermined order.

As an example, each of the electrode 121, the ion exchange membrane 122, and the spacer 123 may have a thin plate or sheet shape. For example, each of the electrode 121, the ion exchange membrane 122, and the spacer 123 may form a hollow space therein.

As an example, the deionization module 120 may include a bipolar type capacitive deionization device. A voltage may be applied by connecting electrode terminals to the two electrodes 121 provided on both sides of the deionization module 120. A dielectric polarization phenomenon may occur in each of the plurality of electrodes 121 provided inside the deionization module 120. Accordingly, a first surface of each of the plurality of electrodes 121 may have an increased amount of positive charge and act as an anode, and a second surface opposite to the first surface of each of the plurality of electrodes 121 may have an increased amount of negative charge and act as a cathode.

The plurality of electrodes 121 may include a first electrode 121a and a second electrode 121b. One surface of the first electrode 121a and one surface of the second electrode 121b may be disposed to face each other. Any one of the one surface of the first electrode 121a and the one surface of the second electrode 121b may act as an anode, and the other one may act as a cathode. Accordingly, an electric field may be formed between the first electrode 121a and the second electrode 121b. Hereinafter, an embodiment will be described in which the one surface of the first electrode 121a acts as an anode and the one surface of the second electrode 121b acts as a cathode.

The ion exchange membrane 122 may include a cation exchange membrane 122a and an anion exchange membrane 122b. The cation exchange membrane 122a may be configured to allow cations to pass through, and the anion exchange membrane 122b may be configured to allow anions to pass through. The cation exchange membrane 122a may be attached to the one surface of the second electrode 121b acting as a cathode, and the anion exchange membrane 122b may be attached to the one surface of the first electrode 121a acting as an anode. However, the ion exchange membrane 122 may be omitted.

The spacer 123 may be disposed between the cation exchange membrane 122a and the anion exchange membrane 122b. The spacer 123 may be configured to allow water to pass through. For example, the spacer 123 may include a mesh material. However, there is no particular restriction on the material of the spacer 123.

Water may pass through the deionization module 120 by flowing inside the spacer 123. Cations contained in water may be adsorbed on the one surface of the second electrode 121b, which acts as a cathode, and anions contained in water may be adsorbed on the one surface of the first electrode 121a, which acts as an anode. The cation exchange membrane 122a and the anion exchange membrane 122b may facilitate the capture of cations and anions, respectively. In addition, the cation exchange membrane 122a and the anion exchange membrane 122b may limit the adsorption of cations or anions on the one surface of the first electrode 121a or the one surface of the second electrode 121b during regeneration of the deionization module 120, respectively.

A method of purifying water by the deionization module 120 and a method of regenerating the deionization module 120 will be described below with reference to FIGS. 8 and 9. For convenience of description, the cation exchange membrane 122a, the anion exchange membrane 122b, and the spacer 123 are omitted from the drawings.

Referring to FIG. 8, as an adsorption voltage is applied to the deionization module 120, the one surface of the first electrode 121a may act as an anode, and the one surface of the second electrode 121b may act as a cathode. At this time, when water moves between the first electrode 121a and the second electrode 121b, which are spaced apart from each other, ionic substances contained in the water may move to the first electrode 121a and the second electrode 121b by electrical attraction. Accordingly, ionic substances having negative charges may be adsorbed on the first electrode 121a, and ionic substances having positive charges may be adsorbed on the second electrode 121b. Therefore, water passed through the deionization module 120 may contain no ionic substances or may contain a very small amount of ionic substances.

When ionic substances continue to accumulate on the first electrode 121a and the second electrode 121b as the water treatment process is continuously performed, the electric field formed between the first electrode 121a and the second electrode 121b may be weakened. Because when the electric field is weakened, ionic substances are not easily adsorbed to the first electrode 121a and the second electrode 121b, the adsorption capacity of the deionization module 120 may be reduced. In order to restore the adsorption performance of the deionization module 120, a regeneration process or a scale removal process may be performed.

Referring to FIG. 10, when the water treatment device 100 according to an embodiment of the present disclosure requires the regeneration process, the regenerative material 190 for removing scale from the deionization module 120 may be put into the accommodation portion 111. The supply opening 113 may be opened as the supply cover 115 is separated from the case 101. The regenerative material 190 may be put into the accommodation portion 111 through the opened supply opening 113. As an example, a user may separate the supply cover 115 positioned inside the tub 12 and feed the regenerative material 190 into the supply opening 113 through the inside of the tub 12. As an example, the regenerative material 190 may include an acid solution for removing scale from the deionization module 120. For example, the acid solution may include a citric acid solution.

Referring to FIG. 9, in order to restore the adsorption capacity of the deionization module 120, a regeneration voltage having a polarity opposite to the adsorption voltage may be applied to the first electrode 121a and the second electrode 121b. Due to the application of a regenerative voltage, the one surface of the first electrode 121a may act as a cathode, and the one surface of the second electrode 121b may act as an anode. Accordingly, the ionic substances attached to the first electrode 121a and the second electrode 121b may be separated from the first electrode 121a and the second electrode 121b.

The water treatment device 100 according to an embodiment of the present disclosure may have an improved structure because the accommodation portion 111 capable of accommodating the regenerative material 190 and the deionization module 120 are provided on a flow path through which water flowed through the inlet port 102 and to be discharged through the discharge port 103 flows. The water treatment device 100 may perform a deionization process in a state in which the regenerative material 190 is not put into the accommodation portion 111, and may perform the regeneration process or the scale removal process in a state in which the regenerative material 190 is put into the accommodation portion 111.

Additionally, even when no voltage is applied to the deionization module 120 and no dielectric polarization phenomenon occurs at the first electrode 121a and the second electrode 121b, the ionic substances may be separated from the first electrode 121a and the second electrode 121b. In this case, because neither the one surface of the first electrode 121a nor the one surface of the second electrode 121b acts as an anode or cathode, the electric field between the first electrode 121a and the second electrode 121b may disappear, and due to this, ionic substances may be separated from the first electrode 121a and the second electrode 121b.

The ionic substances separated from the first electrode 121a and the second electrode 121b may be discharged to the outside together with water. Through this, the adsorption capacity of the deionization module 120 may be restored.

Referring to FIGS. 6 and 11, water from which ionic substances have been removed in the deionization module 120 may flow to a drain flow path 107 through the hollow space 106. Water passed through the drain flow path 107 may be discharged to the outside of the water treatment device 100 through the discharge port 103.

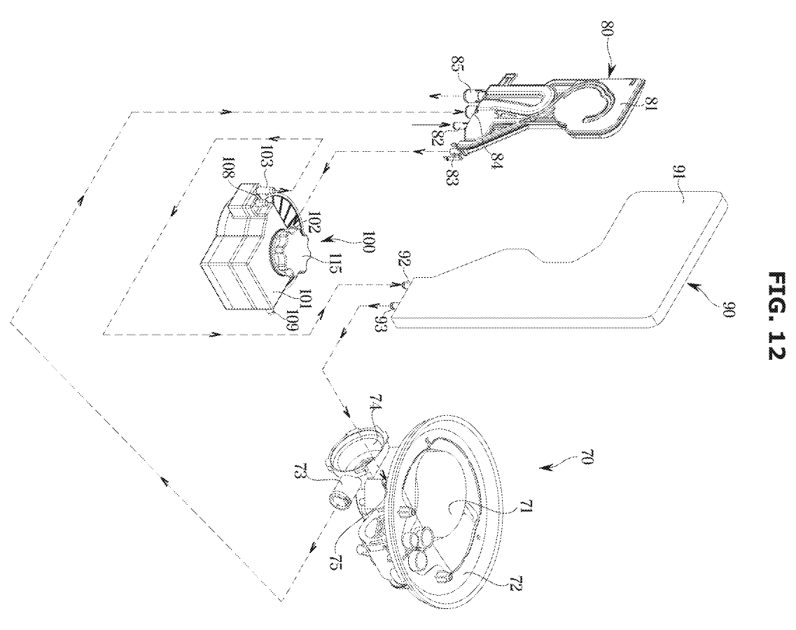

FIG. 12 is a diagram illustrating a connection relationship of the components related to flows of washing water in the dishwasher according to various embodiments.

Referring to FIG. 12, the dishwasher 1 according to an embodiment of the present disclosure may be configured to supply water from the water supply source to the case break 80. As an example, the washing water inlet 82 of the case break 80 may be connected to the water supply source. As an example, the washing water outlet 83 of the case break 80 may be connected to the inlet port 102 of the water treatment device 100. Water discharged from the case break 80 may be introduced into the water treatment device 100.

As an example, the tank inlet 92 of the water tank 90 may be connected to the discharge port 103 of the water treatment device 100. As an example, the tank outlet 93 of the water tank 90 may be connected to the sump 70.

Referring to FIG. 12, the dishwasher 1 according to an embodiment of the present disclosure may be configured such that water supplied from the water supply source passes through the case break 80, undergoes the deionization process in the water treatment device 100, and is supplied to the sump 70 through the water tank 90. As an example, the water tank 90 may be omitted, and the discharge port 103 of the water treatment device 100 may be connected to the sump 70.

A dishwasher according to an example embodiment includes a tub, an injection unit comprising a nozzle configured to inject washing water inside of the tub, a sump configured to accommodate washing water to be supplied to the injection unit, and a water treatment device configured to treat washing water to be supplied to the sump. The water treatment device includes a case including an inlet port and a discharge port, a deionization module comprising an electrode capable of adsorbing ionic substances contained in water supplied through the inlet port, and an accommodation portion comprising a chamber provided on a flow path through which water supplied through the inlet port flows to the deionization module, the accommodation portion being capable of accommodating a regenerative material for removing ions adsorbed on the deionization module.

The case may include a supply opening open toward the inside of the tub and configured to allow the regenerative material to be put into the accommodation portion.

The water treatment device may include a supply cover configured to open and close the supply opening.

The supply cover may be positioned inside the tub.

The water treatment device may include a guide configured to guide water from the accommodation portion to the deionization module. The guide may include an air hole configured to communicate the inside of the guide and the outside of the guide.

The air hole may be positioned at an upper end of the guide.

The air hole may be located at a higher position than the inlet port.

The dishwasher may further include a case break configured to reduce backflow of washing water flowing into the sump.

The inlet port of the water treatment device may be connected to a water supply source. The discharge port of the water treatment device may be connected to a washing water inlet of the case break.

The washing water inlet of the case break may be connected to the water supply source. A washing water outlet of the case break may be connected to the inlet port of the water treatment device.

The dishwasher may further include a water tank configured to be store washing water treated by the water treatment device.

The case may include a connection inlet connected to the washing water outlet of the case break, and a connection outlet connected to a tank inlet of the water tank.

The tank inlet of the water tank may be connected to the washing water outlet of the case break. A tank outlet of the water tank may be connected to the sump.

The tank inlet of the water tank may be connected to the discharge port of the water treatment device. The tank outlet of the water tank may be connected to the sump.

The case break may include a drain inlet configured to allow water discharged from the sump to be introduced, and a drain outlet configured to allow water introduced through the drain inlet to be discharged from the case break.

A dishwasher according to an example embodiment includes a tub, an injection unit configured to inject washing water from the inside of the tub, a sump configured to accommodate washing water to be supplied to the injection unit, and a water treatment device configured to perform water treatment on washing water to be supplied to the sump. The water treatment device includes a case including an inlet port, a discharge port, and a supply opening provided to be opened toward the inside of the tub, a deionization module configured to be capable of adsorbing ionic substances contained in water supplied through the inlet port, an accommodation portion provided on a flow path through which water supplied through the inlet port flows to the deionization module, the accommodation portion being capable of accommodating a regenerative material for removing ions adsorbed on the deionization module, and a guide portion provided to guide water from the accommodation portion to the deionization module, the guide portion including an air hole located at a higher position than the inlet port.

The water treatment device may include a supply cover provided to open and close the supply opening.

The dishwasher may further include a case break provided to reduce backflow of washing water flowing into the sump, and a water tank configured to be capable of storing washing water undergone the water treatment in the water treatment device.

The inlet port of the water treatment device may be connected to a water supply source. The discharge port of the water treatment device may be connected to a washing water inlet of the case break.

A tank inlet of the water tank may be connected to a washing water outlet of the case break. A tank outlet of the water tank may be connected to the sump.

According to the present disclosure, a dishwasher can have an improved structure because a water treatment device includes a deionization module and an accommodation portion capable of accommodating a regenerative material.

Effects obtainable from the present disclosure are not limited to the effects mentioned above, and other effects not mentioned will be clearly understood by those skilled in the art to which the present disclosure belongs.

The foregoing has illustrated and described specific embodiments. However, it should be understood by those of skilled in the art that the present disclosure is not limited to the above-described embodiments, and various changes and modifications may be made without departing from the technical idea of the present disclosure including in the following claims.

What is claimed is:

1. A dishwasher comprising:
a tub;
an injection unit comprising a nozzle configured to inject washing water inside of the tub;
a sump configured to accommodate washing water to be supplied to the injection unit; and
a water treatment device configured to treat washing water to be supplied to the sump,
wherein the water treatment device comprises:
a case comprising an inlet port and a discharge port;
a deionization module comprising an electrode capable of adsorbing ionic substances contained in water supplied through the inlet port; and
an accommodation portion comprising a chamber provided on a flow path through which water supplied through the inlet port flows to the deionization module, the accommodation portion being capable of accommodating a regenerative material for removing ions adsorbed on the deionization module.

2. The dishwasher according to claim 1, wherein
the case comprises a supply opening open toward the inside of the tub and configured to allow the regenerative material to be put into the accommodation portion.

3. The dishwasher according to claim 2, wherein
the water treatment device comprises a supply cover configured to open and close the supply opening.

4. The dishwasher according to claim 3, wherein
the supply cover is positioned inside the tub.

5. The dishwasher according to claim 1, wherein
the water treatment device comprises a guide configured to guide water from the accommodation portion to the deionization module, and
the guide comprises an air hole configured to communicate the inside of the guide and the outside of the guide.

6. The dishwasher according to claim 5, wherein
the air hole is positioned at an upper end of the guide.

7. The dishwasher according to claim 5, wherein
the air hole is located at a higher position than the inlet port.

8. The dishwasher according to claim 1, further comprising
a case break configured to reduce backflow of washing water flowing into the sump.

9. The dishwasher according to claim 8, wherein
the inlet port of the water treatment device is connected to a water supply source, and
the discharge port of the water treatment device is connected to a washing water inlet of the case break.

10. The dishwasher according to claim 8, wherein
a washing water inlet of the case break is connected to a water supply source, and
a washing water outlet of the case break is connected to the inlet port of the water treatment device.

11. The dishwasher according to claim 8, further comprising
a water tank configured to be store washing water treated by the water treatment device.

12. The dishwasher according to claim 11, wherein
the case comprises:
a connection inlet connected to a washing water outlet of the case break; and
a connection outlet connected to a tank inlet of the water tank.

13. The dishwasher according to claim 11, wherein
a tank inlet of the water tank is connected to a washing water outlet of the case break, and
a tank outlet of the water tank is connected to the sump.

14. The dishwasher according to claim 11, wherein
a tank inlet of the water tank is connected to the discharge port of the water treatment device, and
a tank outlet of the water tank is connected to the sump.

15. The dishwasher according to claim 8, wherein
the case break comprises:
a drain inlet configured to allow water discharged from the sump to be introduced; and
a drain outlet configured to allow water introduced through the drain inlet to be discharged from the case break.
